(19) United States
(12) Patent Application Publication
(10) Pub. No.: US 2013/0212714 A1
(43) Pub. Date: Aug. 15, 2013

(54) Information Management System And Device

(71) Applicants: Kim Yam Goh, Singapore (SG); Fook Choon Ee, Singapore (SG)

(72) Inventors: Kim Yam Goh, Singapore (SG); Fook Choon Ee, Singapore (SG)

(73) Assignee: ST Electronics (Info-Software Systems) Pte Ltd., Singapore (SG)

(21) Appl. No.: 13/878,227

(22) PCT Filed: Oct. 10, 2011
(86) PCT No.: PCT/SG2011/000353

§ 371 Date: Apr. 7, 2013

(30) Foreign Application Priority Data
Oct. 12, 2010 (SG) 201007475-5

(51) Int. Cl. G06F 21/86

(52) U.S. Cl. CPC G06F 21/86
USPC 726/34

(57) ABSTRACT

The present invention relates to an information management system, and in particular to a portable information management device. The device includes a housing having a first surface and a second surface, said first and second surfaces securely enclosing electronic componentry of the device, wherein the electronic componentry includes: a data storage device for storing information about a person or asset; and a processor for transferring the information from the data storage device to an external device via a communication means, wherein the communication means includes: an antenna to allow contactless transfer of the information; and an input/output interface to allow transfer of the information via physical means.

### FIELD OF THE INVENTION

The present invention relates to an information management system, and in particular to a portable information management device.

### BACKGROUND TO THE INVENTION

There are various instances which require a person's identity to be established and/or personal information made known to third parties. For example, if a person is involved in an accident their name and contact details need to be provided to the emergency services and hospital, or the police may require a person to be identified if involved in a crime, or government departments may require a person to be identified to pay welfare and health care benefits.

These details are currently provided by the persons themselves (eg voice), or through details stored on a secure identification card (eg a driver's licence) or inscribed on a wearable metallic pendant.

These solutions are however very limited as they require a person to know the details and be able to explain those details, eg medical history, in times when it may be difficult, eg when involved in an accident. Further, data stored on a card or inscribed on a pendant is very limited in terms of the amount and type of information that can be stored and retrieved.

It is desirable to provide a system which enables greater flexibility in the storage and retrieval of personal information.

### SUMMARY OF THE INVENTION

In one aspect, the present invention provides a portable information management device including: a housing having a first surface and a second surface, said first and second surfaces securely enclosing electronic componentry of the device, wherein the electronic componentry includes: a data storage device for storing information about a person or asset; and a processor for transferring the information from the data storage device to an external device via a communication means, wherein the communication means includes: an antenna to allow contactless transfer of the information; and an input/output interface to allow transfer of the information via physical means.

Preferably, the antenna is configured to allow transfer of information when either the first or second surfaces are in close proximity to a reader. This provides simpler and faster data transfer as the user is not restricted to certain locations or orientations for the device.

Ideally, the antenna is configured to allow transfer of information from within a distance of about 3 cm from the first surface or second surface. This is small enough to mitigate unauthorised third parties from obtaining information stored on the device during a transfer process, yet far enough for fast and easy use by an authorised user.

The data storage device may include a memory having a plurality of secure memory segments configured to store selected information in separate memory segments. This enhances the security and usability of the device, as sensitive information can be stored separately to non-sensitive information and be accessible only by selected users.

The housing may be marked with visual identification information for added security.

Advantageously, the data storage device may have a capacity of at least 1 GB. This allows images and videos to be stored on the device, for example a patient's medical records or photographs.

In one form, the device weighs approximately 10 grams, making it lightweight for a person to wear or carry 24 hours a day. Ideally, the maximum dimensions of the housing of the portable information management device are approximately 45 mm×33 mm×6 mm.

The present invention also provides an information management system including: a portable information management device according to the first aspect; a server for receiving information to be transferred to said management device and transferring said information to said management device via a reader, said reader including at least an antenna to allow contactless transfer of the information to the management device, and an input/output interface to allow transfer of the information via physical means.

A noise source generator may also be included in the system to generate encryption keys for added security during data transfer to and from the device and at rest.

Forms of the present invention provide a more secure and usable device for storage and retrieval of personal information by providing a compact and lightweight device which can be worn or carried by a person 24 hours a day, yet has a large storage capacity for storing large files of information. A dual memory storage feature provides greater security and privacy in the storage of sensitive information.

### BRIEF DESCRIPTION OF THE DRAWINGS

An illustrative embodiment of the present invention will now be described with reference to the accompanying figures. Further features and advantages of the invention will also become apparent from the accompanying description.

FIG. 1 shows an information management system according to one embodiment;

FIG. 2A is a plan view and a bottom view of the housing of an information management device according to one embodiment;

FIG. 2B is a plan view and a bottom view of the electronic circuits inside the housing of FIG. 2A according to one embodiment;

FIG. 2C shows a safety shield which may be used to protect the device according to one embodiment;

FIG. 3 is a block diagram showing the electronic componentry of the device of FIG. 2A according to one embodiment;

FIG. 4A is a perspective view of the housing of the reader of the information management system according to one embodiment;

FIG. 4B shows the reader of FIG. 4A with the base cover removed showing one of the electronic circuits according to one embodiment;

FIG. 4C shows the reader of FIG. 4A with the top cover removed showing the showing one of the electronic circuits according to one embodiment;

FIG. 5 is a block diagram showing the electronic componentry of of the reader of FIG. 4A according to one embodiment.

### DESCRIPTION OF PREFERRED EMBODIMENT

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

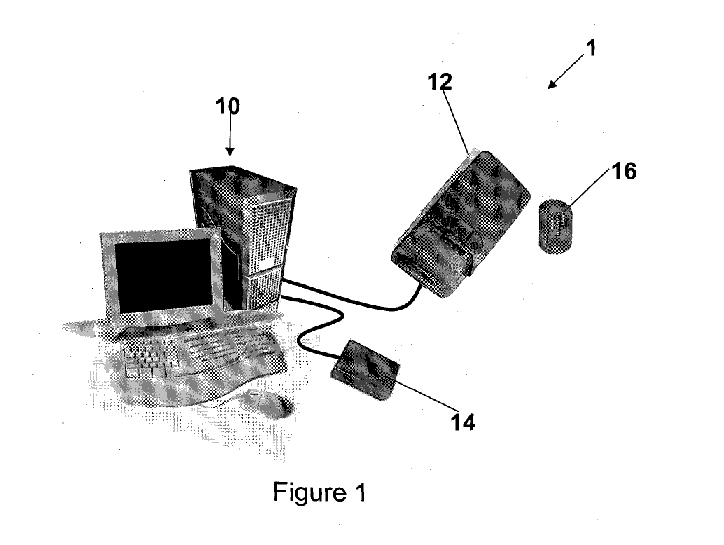

FIG. 1 shows an information management system 1 including a management server 10, a contact and contactless reader 12, a noise source generator 14, and a portable information management device 16. The reader 12 and generator 14 are connected to the server 10 via USB cables, although other connection means, including wireless connection, could be used.

The server 10 operates software for receiving and displaying data stored on the device 16, and communicating with the reader to transfer data from the server 10 onto the device 16. Data to be transferred onto the device 16 is inputted onto the server 10 via flat file electronic transfer, a keyboard or other suitable input interface for example a mouse, touch screen, or the like. The server 10 is connected to the reader 12 via a USB cable, and the data to be transferred is sent to and/or retrieved from the device 16 via the reader 12.

The noise source generator 14 is connected to the server 10 and generates random noise signals for encryption keys as a security measure to prevent unauthorised systems obtaining data being transferred wirelessly between the device 16 and the reader 12. Preferably, a noise generator that is certified to the US Government Securty Standard FIPS 140-2 is used to offer the highest level of nondeterministic randomness for generating high grade encryption keys.

The reader 12 transfers data onto, and receives data from, the device 16 via either contact and/or contactless means. The contactless means is provided by transmission of a radio frequency using frequency of 13.56 MHz, although other suitable wireless means, such as WIFI® or Bluetooth® could be used in other embodiments. Ideally the transmission distance will be approximately 3 cm, large enough for ease of use yet small enough to prevent unauthorised parties accessing the frequency and data during transfer. The contact means is provided by a proprietary USB look-alike interface which connects to a mating interface on the device 16. The proprietary interface provides greater flexibility for design to other future interfaces and allows a smaller footprint device 16 to be used with different shapes and curvatures. The proprietary interface also adds a layer of physical security as it is unique to the device 16 and only the matched reader is able to extract information from it. The proprietary interface has a 5 pins “pin out” arrangement (as opposed to the 4 pins in standard USB). The additional pin is used for an additional power supply pin. This design reduces the need for an additional power regulator within the device 16, thus reduces the overall dimension. In other embodiments, a standard USB interface, a 5-pin bus interface or other suitable connection interface could be equally used.

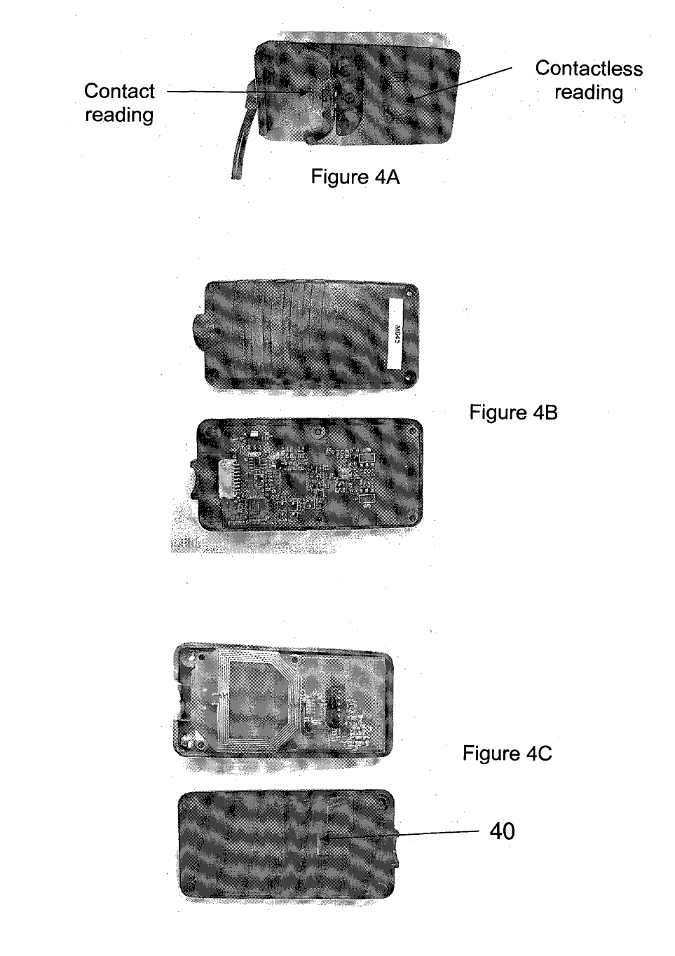

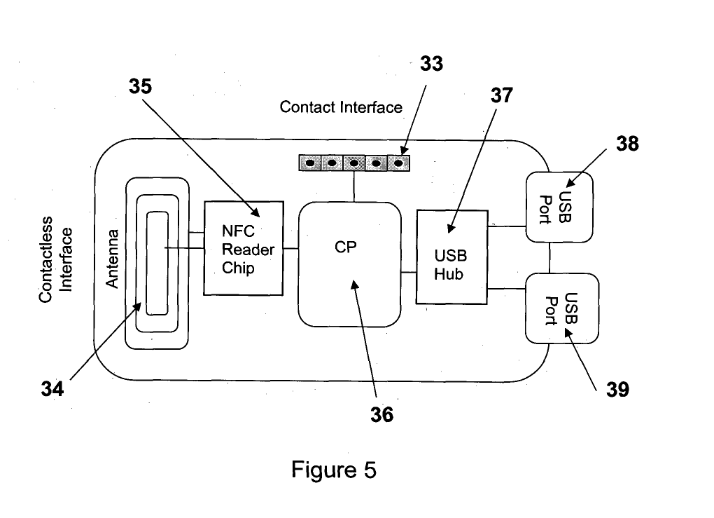

FIGS. 4A, 4B, 4C and 5 show one embodiment of the reader 12. The reader 12 includes a matching 5 pins USB-like interface 33, an antenna 34 for wireless interface to the device 16, an NFC reader chip 35, a 16 bit CPU 36, a USB hub 37, a first USB port 38 and a second USB port 39. The physical casing of the reader 12 is formed of a top and base cover which are clipped or otherwise held together.

The top cover includes a slider mechanism 40 to connect the interface 33 to the device 16. The reader 12 has a unique physical interface with the 5 pin contact that allows the device 16 to slide into the slot created to hold the device 16. With the slider mechanism on the reader 12, the device 16 once fitted into the slot will be locked in place with the slider. This ensures that during the reading and writing process, the device 16 will not drop out. This design has two advantages: it allows a one hand operation while putting in the device 16. This design frees the user to operate or hold or do something else with the other hand. The other advantage is it allows movement or motion while the device 16 content is being written or read. Unlike a conventional USB interface, no parts of the device 16 will be protruding out of the reader 12.

The reader 12 has also a matching NFC interface to the device 16 at 13.56 Mhz. With an internal 16 bit CPU and USB hub, it acts as an intermediary to the device 16 and the server 10. The reader 12 also supplies power to the device 16 for its operation. Internally, it has a USB hub, which expands the computer USB port that it connects to. Thus it enables another USB device to be plugged in while it is utilising the port. The USB resource of the computer is therefore duplicated.

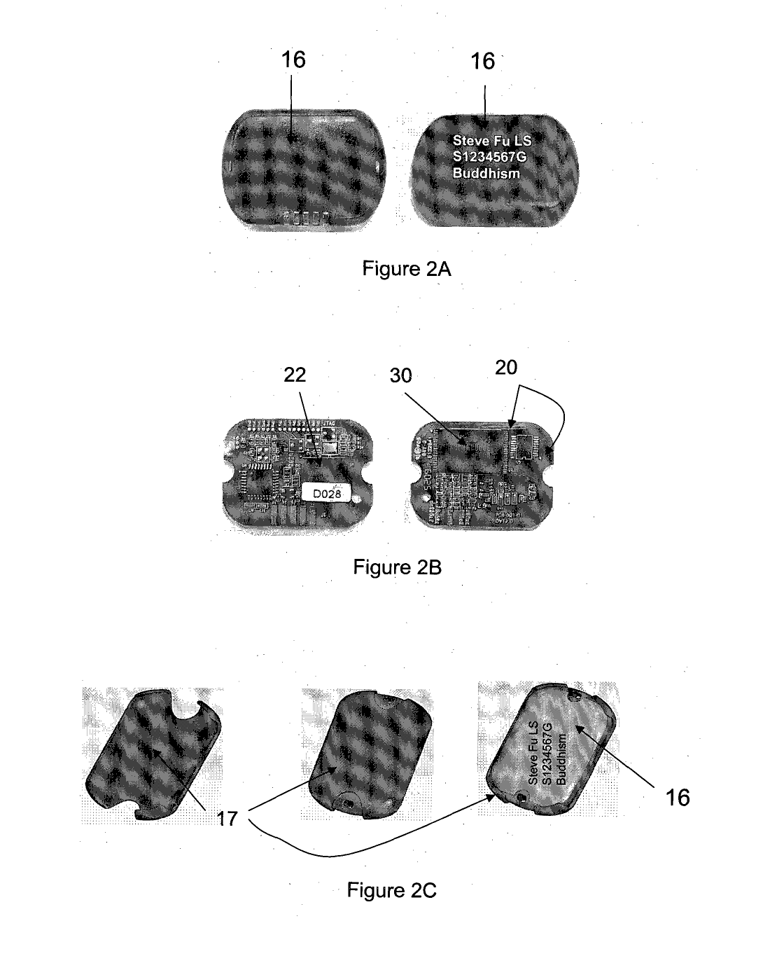

FIGS. 2A, 2B and 2C show an exemplary embodiment of the device 16. The dimensions of the device 16 are preferably relatively small to enable the device 16 to be easily carried by a user or worn in a chain around the user's neck or the like. For example, the dimensions may be 45 mm (length)×32 mm (width)×6 mm (depth), all within an error range of about ±1 mm, although other dimensions could equally be used, such as a depth range of anywhere between 6 mm to 15 mm. The weight of the device 16 is preferably about 10±1 gram, making it lightweight for ease of wearability. The outer surfaces of the device 16 may be formed of a plastic material such as PC-ABS which is lightweight yet strong and durable. The outer surfaces may advantageously comprise only two surfaces which are joined together at the edges via clips, welding, screws, or other suitable connection means. One or both of the outer surfaces may be engraved or otherwise stamped or marked with visual identification such as a name or number as shown in FIG. 2A. To prevent the chance of a possible unintentional activation of the contactless circuitry in device 16, a specially designed shield 17 can be added to device 16, such as that shown in FIG. 2C. The shield 17 may be made from conductive rubber which also doubles up as a noise damper. The conductive rubber acts as a EMI/RFI shield when mounted on the device 16. This shield is used to provide intended prevention of any contactless operation i.e. contactless reading of device 16 information even when a reader is placed over the device 16.

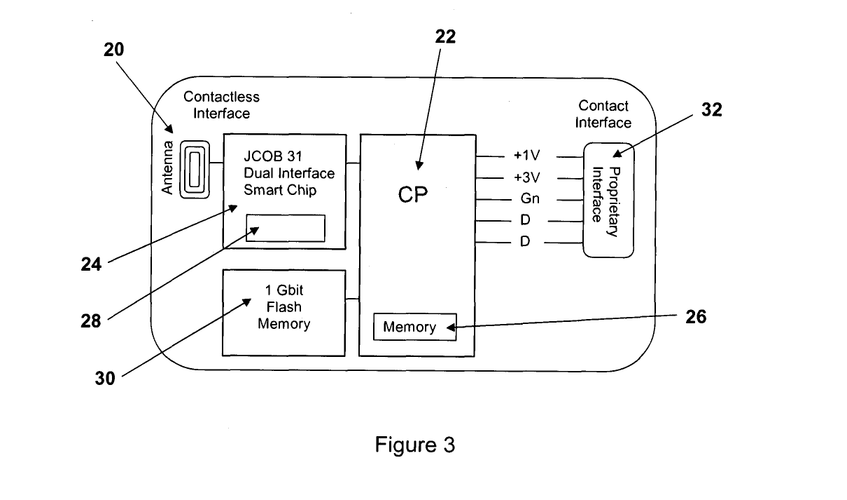

The interior of the device 16 contains the electronic componentry as shown in FIG. 3. The componentry includes an antenna 20, a processor 22 having an NFC Dual Interface Smart Chip 24, a first memory chip 26, a second memory chip 28, a third flash memory chip 30, and a proprietary interface 32 The device 16 chip processor 22 is based on RISC 32 bit processor that is low power and yet powerful enough to handle all the communications and the security requirement. It can run up to 200 Mhz. The program for the RISC processor will be stored in the memory 26 on the chip 22.

To enable the device 16 to be wearable and carried around without weight stress, a no battery design is preferred. The device 16 does not need a battery to operate. The contactless read/write sessions capitalize on the technology of a passive RFID read/write setup while power can be provided externally through the interface pins for contact read/write sessions.

The antenna 20 is used to receive and transmit data to and from the device 16 wirelessly via the radio frequency or other suitable near field communication means. As noted above, preferably the wireless reading distance is about 3 cm±10%. This protects the data from unauthorised access by third parties accessing similar frequencies. Wireless data transfer via this method is relatively fast and convenient, however only limited data capacity can be transferred, eg 72 kB. The location of the antenna allows receiving and transmitting of data from both the first and second surfaces of the device—in other words, either side of the device may be in closer proximity to the reader 12 and the data transfer will occur. This makes the device 16 much simpler and faster to use.

The antenna 20 is designed such that it enables both side of the device 16 to be read, and yet keep within the preferred dimensions of the device 16. The antenna 20 may be designed as circles or traces around the edge of the PCB with a 2 mm clearance from the nearest chips. No components or chips are mounted below the PCB antenna 20 traces. In saving space and increasing the distance performance of the wireless device 16, the chips are placed within these circles of antenna 20 traces. This is different from standard design whereby the electronic components are placed outside the antenna loop. By achieving this working design, space can be saved without sacrificing distance performance.

To allow greater transfer and storage of data, the proprietary USB-like interface 32 is provided. The device 16 can be plugged into the reader 12 via the mating USB-like interface 32 to allow the transfer of data. The contact interface allows high speed data transfer for larger files for example images and video.

The first and second memory chips 26, 28, allow data to be separately stored in different locations on the device 16 for added security. For example, sensitive personal data may be stored on the first chip 26 such as secured keys and encryption algorithms and the like, and other less-sensitive data stored on the second chip 28. Different security levels may then be applied to users of the system to access the data stored on the two different memory chips 26, 28. It is preferred that the storage capacity on the device 16 is at least 1 GB, as this will allow substantial amounts of images and video to be stored. The memory chips 26, 28 are connected via an interconnecting chip 24 which is controlled by the processor 22. The interconnecting chip 24 acts as the bridge between data passing through back and forth between the memory chips 26, 28.

The three different memories on the device 16 each play different roles in the device. The RISC CPU 22 internal memory stores the program of the CPU 22, which handles the moving of secured data in and out of the device 16. The external flash memory 30 stores the secured data, while the Smart Chip Memory 28 stores secured keys, encryption algorithm and the wireless interface program. This organisation of the memories ensures maximum protection of the secured data. Typical RFID devices have not in the past had large memory because of the limited space on the devices, and limited processor memory access capacity. In the present embodiment, an RISC based processor is integrated with a large memory access to act as the contact interface.

The size and weight of the embodiment described makes it ideal for use as a wearable pendant. However, as a person skilled in the art will immediately recognise, the same principles and technology may be used in other embodiments and devices having varying dimensions and uses.

It is envisaged that the information management device could be implemented by governments to store identity information about residents, and which will require every resident to carry a device with them at all times. It can also be used to store health and medical records, especially for users who may have existing medical conditions such as diabetes or is wearing a heart monitor. The device could also replace identity cards such as drivers licences, health care cards, store cards, etc with all information conglomerated onto the one device.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment.

Furthermore, the particular features, structures, or characteristics may be combined in any suitable manner in one or more combinations. It will be appreciated that persons skilled in the art could implement the present invention in different ways to the one described above, and variations may be produced without departing from its spirit and scope.

Any discussion of documents, devices, acts or knowledge in this specification is included to explain the context of the invention. It should not be taken as an admission that any of the material forms part of the prior art base or the common general knowledge in the relevant art, in any country, on or before the filing date of the patent application to which the present specification pertains.

1. A portable information management device comprising:
a housing having a first surface and a second surface, said first and second surfaces securely enclosing electronic componentry of the device, wherein the electronic componentry comprises:
a data storage device for storing information about a person or asset, said data storage device comprises a memory having a plurality of secure memory segments configured to store selected information in separate memory segments; and
a processor for transferring the information from the data storage device to an external device via a communication means,
wherein the communication means comprises:
an antenna to allow contactless transfer of the information; and
input/output interface to allow transfer of the information via physical means.

2. A portable information management device according to claim 1, wherein said plurality of secure memory segments are configured with different levels of security access.

3. A portable information management device according to claim 1, wherein the antenna is configured to allow transfer of information when either the first or second surfaces are in close proximity to a reader.

4. A portable information management device according to claim 1, wherein said housing is marked with visual identification information.

5. A portable information management device according to claim 4, wherein said housing is marked by engraving, silkscreen or punching.

6. A portable information management device according to claim 1, wherein said data storage device has a capacity of at least 1 GB.

7. A portable information management device according to claim 1, wherein said antenna is configured to allow transfer of information from within a distance of about 3 cm from the first surface or second surface.

8. A portable information management device according to claim 1, wherein the management device weighs approximately 10 grams.

9. A portable information management device according to claim 1, wherein the maximum dimensions of the housing of the management device are approximately 50 mm×35 mm×6 mm.

10. An information management system comprising:
a portable information management device according to any one of claims 1 to 9;
a server for receiving information to be transferred to said management device and transferring said information to said management device via a reader, said reader comprising at least an antenna to allow contactless transfer of the information to the management device, and an input/output interface to allow transfer of the information via physical means.

11. An information management system according to claim 10, further comprising a noise source generator.
